(19) United States
(12) Patent Application Publication
(10) Pub. No.: US 2007/0135576 A1
(43) Pub. Date: Jun. 14, 2007

(54) Thermoplastic elastomer composition

(75) Inventor: Naoyuki Ono, Tokyo (JP)

Correspondence Address: OLIFF & BERRIDGE, PLC, P.O. BOX 19928, ALEXANDRIA, VA, 22320, US

(73) Assignee: RIKEN TECHNOS CORPORATION, TOKYO (JP)

(21) Appl. No.: 11/639,214

(22) Filed: Dec. 15, 2006

(30) Foreign Application Priority Data
Jun. 18, 2004 (JP) 2004-181520

(51) Int. Cl. C08F 8/00

(52) U.S. Cl. 525/192

(57) ABSTRACT

The present invention provides a thermoplastic elastomer composition comprising (a) 100 parts by weight of an ethylene-α-olefin-unconjugated polyene copolymer rubber synthesized with a metallocene, (b) 20 to 350 parts by weight of a crystalline olefin resin, (c) 2 to 25 parts by weight of a cross-linking agent, and (d) 5 to 120 parts by weight of at least one polymer selected from the group consisting of a copolymer of a vinyl aromatic compound with a conjugated diene compound, a hydrogenated copolymer obtained by hydrogenating a copolymer of a vinyl aromatic compound with a conjugated diene compound, and a hydrogenated polymer obtained by hydrogenating a polymer of a conjugated diene compound. The thermoplastic elastomer composition according to the present invention is excellent in compression set and oil resistance at high temperatures and in flexibility and moldability.

### FIELD OF THE INVENTION

The present invention relates to a thermoplastic elastomer composition, particularly, a thermoplastic elastomer composition which is excellent in a compression set property and oil resistance at high temperatures and in flexibility and moldability.

### BACKGROUND OF THE INVENTION

In recent years, much use have beenmade of thermoplastic elastomers which are soft materials with rubber elasticity, do not require a vulcanization process, have molding processability similar with that of thermoplastic resins and are recyclable in fields such as automobile parts, light electric appliance parts, wire coverings, medical device components, footwear, and miscellaneous goods.

Among the thermoplastic elastomers, polystyrenic thermoplastic elastomers such as a styrene-butadiene block copolymer (SBS) and a styrene-isoprene block copolymer (SIS) which are block copolymers of a vinyl aromatic compound with a conjugated diene compound have high flexibility and good rubber elasticity at ambient temperature. In addition, thermoplastic elastomer compositions obtainable from these elastomers are excellent in processability and are widely used as a substitute for vulcanized rubber.

Further, elastomer compositions of a hydrogenated elastomer in which intramolecular double bonds in a block copolymer of styrene with a conjugated diene are hydrogenated are more widely used as an elastomer having improved heat-aging resistance or heat stability and weather resistance.

However, the thermoplastic elastomer compositions of such a hydrogenated block copolymer still have problems in rubber properties such as oil resistance, deformation under heat and load or compression set, and rubber elasticity at high temperatures. In order to improve these properties, cross-linked compositions have been proposed which are obtained by cross-linking a composition comprising the aforesaid hydrogenated block copolymer (see, for example, patent literatures 1 to 5 listed hereinbelow).

However, thecross-linked composition comprising the hydrogenated block copolymers which is disclosed in the patent literatures is still unsatisfactory in compression set at high temperatures, in particular, at 100° C. or higher, tends to have decreased mechanical properties, and, therefore, does not meet the performance requirements for the conventional vulcanized rubber. Further, the composition has many problems on molding processability. For example, in extrusion molding, melt tension at high temperatures is low, so that retention of shape is difficult. In injection molding, a molding cycle or molding time is longer.

As another thermoplastic elastomer, an olefinic thermoplastic elastomer is known which is obtained by cross-linking rubber and an olefinic resin. This elastomer has comparatively high hardness and, therefore, a plasticizer is usually used to provide the elastomer with flexibility. However, the plasticizer causes a problem that it bleeds out gradually from the elastomer. In order to solve this problem, a thermoplastic elastomer composition is known which further comprises a block copolymer of stylene with a conjugated diene (see, for example, patent literature 6). Also, in order to further improve the mechanical strength of the olefinic thermoplastic elastomer, a thermoplastic elastomer composition is known which is obtained by dispersing highly-crosslinked rubber into an olefinic resin and then adding a stylenic thermoplastic block copolymer (see, for example, patent literature 7). These compositions are inferior in moldability because EPDM synthesized using a Ziegler catalyst is used as rubber.

1. Japanese Patent Application Laid-Open No. 59-6236/1984

2. Japanese Patent Application Laid-Open No. 63-57662/1988

3. Japanese Patent Publication No. 3-49927/1991

4. Japanese Patent Publication No. 3-11291/1991

5. Japanese Patent Publication No. 6-13628/1994

6. Japanese Patent Application Laid-Open No. 62-62847/1987

7. Japanese Patent Application Laid-Open No. 64-24839/1989

### DISCLOSURE OF THE INVENTION

It is an object of the present invention to provide a thermoplastic elastomer composition which is excellent in compression set and oil resistance at high temperatures and in flexibility and moldability.

Thus, the present invention provides
(1) a thermoplastic elastomer composition, characterized in that it comprises
(a) 100 parts by weight of an ethylene-α-olefin-unconjugated polyene copolymer rubber synthesized with a metallocene catalyst,
(b) 20 to 350 parts by weight of a crystalline olefin resin,
(c) 2 to 25 parts by weight of a cross-linking agent, and
(d) 5 to 120 parts by weight of at least one polymer selected from the group consisting of a copolymer of a vinyl aromatic compound with a conjugated diene compound, a hydrogenated copolymer obtained by hydrogenating a copolymer of a vinyl aromatic compound with a conjugated diene compound, and a hydrogenated polymer obtained by hydrogenating a polymer of a conjugated diene compound.

The present invention further provides the following:
(2) a thermoplastic elastomer composition according to the aforesaid (1), wherein it further comprises (e) a cross-linking promoter in an amount of 20 parts by weight or less,
(3) a thermoplastic elastomer composition according to the aforesaid (2), wherein the component (e) is at least one selected from the group consisting of zinc oxide, magnesium oxide and tin dichloride,
(4) a thermoplastic elastomer composition according to the aforesaid (2), wherein the component (e) is zinc oxide in an amount of 0.05 to 20 parts by weight,
(5) a thermoplastic elastomer composition according to the aforesaid (2), wherein the component (e) is tin dichloride in an amount of 0.1 to 10 parts by weight,
(6) a thermoplastic elastomer composition according to any one of the aforesaid (1) to (5), wherein it further comprises (f) a non-aromatic softening agent for rubber in an amount of 480 parts by weight or less,
(7) a thermoplastic elastomer composition according to any one of the aforesaid (1) to (6), wherein the component (c) is at least one selected from the group consisting of phenolic resins and brominated phenolic resins,
(8) a thermoplastic elastomer composition according to any one of the aforesaid (1) to (7), wherein the component (c) is an alkylphenol-formaldehyde resin,
(9) a thermoplastic elastomer composition according to any one of the aforesaid (1) to (8), wherein it comprises (g) an organic peroxide in an amount of 0.01 to 0.5 part by weight, and
(10) a shaped article obtained from a thermoplastic elastomer composition according to any one of the aforesaid (1) to (9).

The thermoplastic elastomer composition according to the present invention is excellent in compression set and oil resistance at high temperatures and in flexibility and moldability. Therefore, the composition can be suitably used as a material for automobile parts including brake parts, parts of hydraulically or pneumatically operated apparatus and elastomeric polymer based-parts.

### PREFERRED EMBODIMENTS OF THE INVENTION

The components for the thermoplastic elastomer composition according to the present invention, the production of the composition and the applications of the composition will be elucidated below.

1. Components of the Thermoplastic Elastomer Composition

Component (a):

Component (a) is an ethylene-α-olefin-unconjugated polyene copolymeric rubber synthesized with a metallocene catalyst. The rubber is a copolymer obtained by polymerizing ethylene with an α-olefin having 3 to 20 carbon atoms, such as propylene, 1-butene or 1-pentene, and an unconjugated polyene compound.

As the aforesaid unconjugated polyene, an unconjugated diene is preferred, such as5-ethyliden-2-norbornene (ENB), 1,4-hexadiene, 5-methylene-2-norbornene (MNB), 1,6-octadiene, 5-methyl-1,4-hexadiene, 3,7-dimethyl-1,6-octadiene, 1,3-cyclopentadiene, 1,4-cyclohexadiene, tetrahydroindene, methyl tetrahydroindene, dicyclopentadiene, 5-isopropyliden-2-norbornene, 5-vinyl-norbornene, dicyclooctadiene and methylenenorbornene.

Examples of Component (a) include, for example, ethylene-propylene-unconjugated diene copolymeric rubber and ethylene-1-butene-unconjugated diene copolymeric rubber. Ethylene-propylene-unconjugated diene copolymeric rubber (EPDM) is preferred because of its cross-linking property with a cross-linking agent.

Component (a) is one synthesized with a metallocene catalyst. The metallocene catalyst is a single-site catalyst or a semimulti-site catalyst and is distinguished from a multi-site catalyst such as a Ziegler catalyst. The metallocene catalyst is known per se and is a polymerization catalyst with high activity which is composed of a cyclopentadienyl derivative of a transition metal such as titanium and zirconium and a cocatalyst. The metallocene catalyst is excellent in controlling a molecular weight distribution, a viscosity and an unconjugated polyene content of the polymer obtained and makes less difference among lots and within a lot of the polymer obtained. As a result, when an ethylene copolymeric rubber polymerized with a metallocene catalyst is used in a composition, the composition generates less die build-up in molding or yields a shaped article having an improved specular surface or a surface with less hard spots. On the other hand, when an ethylene copolymeric rubber polymerized with a multi-site catalyst such as a Ziegler catalyst is used instead of Component (a), the composition obtained tends to generate die build-up in molding or to yield a shaped article having flow marks or hard spots.

An ethylene content in Component (a) is preferably in the range of 40 to 80% by weight, more preferably of 50 to 75% by weight. Particularly the range of 55 to 75% by weight is preferred, as balance is good between productivity and compression set and/or tensile strength at a high temperature of the composition obtained. A content of the unconjugated polyene is preferably 0.5 to 8% by weight, more preferably 4 to 8% by weight. If the content is less than the lower limit, the composition obtained is unsatisfactory in compression set.

Component (a) preferably has a Mooney viscosity, ML₁₊₄ (125° C.), of 10 to 180, more preferably 20 to 150. If the Mooney viscosity, ML₁₊₄ (125° C.), is less then 10, compression set of the thermoplastic elastomer composition obtained will be worse. If it exceeds the upper limit, moldability will be worse.

Commercially available component (a) includes, for example, Nordel IP 4760P, 4725P and 4770R and Nordel MG 47130, 46140 47100 and 47085 all of which are trade names from DuPont Dow Elastomer Japan.
Component (b):

Component (b) is a crystalline olefin resin and is used for the purpose of improving oil resistance, adjusting hardness and improving moldability of the thermoplastic elastomer composition.

Examples of Component (b) include a crystalline homopolymer of ethylene or propylene, or a crystalline copolymer composed mainly of ethylene or propylene. Specifically mentioned are crystalline ethylenic polymers such as high density polyethylene, low density polyethylene and ethylene-butene-1 copolymer, and a crystalline propylenic copolymer such as isotactic polypropylene, propylene-ethylene copolymer, propylene-butene-1 copolymer and propylene-ethylene-butene-1 terpolymer. Among them, propylenic polymers are preferred.

A melting point of Component (b) as determined by DSC is preferably 50° C. or higher, more preferably 130° C. or higher, still more preferably 140° C. or higher, particularly 150° C. or higher. Here, a melting point as determined by DSC refers to a peak top melting point determined by a differential scanning calorimeter (DSC). Specifically, it is a value measured with a DSC by taking a sample amount of 10 mg, holding the sample at 190° C. for 5 minutes, then cooling the sample down to −10° C. at a cooling speed of 10° C./min. to crystallize, holding the sample at −10° C. for 5 minutes, and doing scanning up to 200° C. at a heating speed of 10° C./min.

The amount of Component (b) in the formulation is 20 to 350 parts by weight, preferably 20 to 220 parts by weight, more preferably 30 to 150 parts by weight per 100 parts by weight of Component (a) If it exceeds the upper limit, compression set will be worse. If it is less than the lower limit, oil resistance, productivity and moldability will be worse.
Component (c):

Component (c) is a cross-linking agent. Use may be made of any cross-linking agents that are capable of cross-linking Component (a), except organicperoxides. Component (c) includes, for example, phenolic resins, maleimides and silicon-containing cross-linking agents. Among them, phenolic resin cross-linking agents are preferred.

The preferred phenolic resin cross-linking agent is called a resol resin and may be prepared by condensing alkyl-substitured phenols or non-substituted phenols with aldehyde, preferably formaldehyde, in an alkaline medium or by condensing bifunctional phenol-dialcohol. Alkyl substituents in the alkyl-substituted phenol typically has 1 to 10 carbon atoms. Dimethylol phenols or phenolic resins having an alkyl substituent with 1 to 10 carbon atoms at the para position are preferred. These phenolic cross-linking agents are typically thermoplastic resins and called phenolic resin cross-linking agents or phenolic resins. Specific examples for cross-linking thermoplastic vulcanized rubber with a phenolic resin are described in U.S. Pat. Nos. 4,311,628, 2,972,600 and 3,287,440, the techniques of which may also be used in the present invention.

Examples of the preferred phenolic resin cross-linking agents are represented by the formula (I): 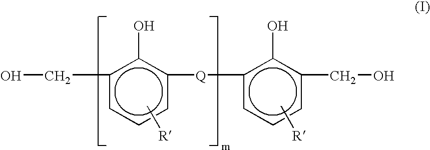
wherein Q is a divalent group selected from the group consisting of —CH₂— and —CH₂—O—CH₂—, m is 0 or a positive integer of 1 to 20, and R′ is an organic group.

Preferably, Q is a divalent group, —CH₂—O—CH₂—, m is 0 or a positive integer of 1 to 10, and R′ is an organic group having less than 20 carbon atoms. More preferably, m is 0 or a positive integer of 1 to 5, and R′ is an organic group having 4 to 12 carbon atoms.

Among the aforesaid phenolic resins, more preferred are an alkylphenol-formaldehyde resin and a methylolated alkylphenolic resin. A phenolic resin whose terminal hydroxyl group(s) is(are) brominated, such as a brominated alkylphenolic resin, is also preferred. Particularly preferred is an alkylphenol-formaldehyde resin.

Examples of the commercially available phenolic cross-linking agents are Tackrol 201 (alkylphenol-formaldehyde resin ex Taoka Chemical Co.), Tackrol 250-I (brominated alkylphenol-formaldehyde resin with 4% of bromination, ex Taoka Chemical Co.), Tackrol 250-III (brominated alkylphenol-formaldehyde resin ex Taoka Chemical Co.), PR-4507 (ex Gun Ei Chemical Co.), Vulkaresat 510E (ex Hoechst Co.), Vulkaresat 532E (ex Hoechst Co.), Vulkaresen E (ex Hoechst Co.), Vulkaresen 105E (ex Hoechst Co.), Vulkaresen 130E (ex Hoechst Co.), Vulkaresol 315E (ex Hoechst Co.), Amberol ST 137X (ex Rohm & Haas Co.), Sumilite Resin PR-22193 (ex Sumitomo Durez Co.), Symphorm-C-100 (exAnchor Chemical Co.), Symphorm-C-1001 (exAnchor Chemical Co.), Tamanol 531 (ex Arakawa Chemical Co.), Schenectady SP1059 (ex Schenectady Chemical Co.), Schenectady SP1045 (ex Schenectady Chemical Co.), CRR-0803 (ex Union Carbide Corp.), Schenectady SP1055 (ex Schenectady Chemical Co.), Schenectady SP1056 (ex Schenectady Chemical Co.), CRM-0803 (ex Showa Union Gosei Co.) and Vulkadur A (ex Bayer Co.). Among them, preferably used is Tackrol 201 (alkylphenol-formaldehyde resin).

The aforesaid silicon-containing cross-linking agent generally includes silicon hydride compounds having at least one SiH group. These compounds react with carbon-carbon double bonds of an unsaturated polymer in the presence of a hydrosilylating catalyst. Useful silicon hydride compounds for working the present invention include, without being limited thereto, methylhydrogen polysiloxanes, methylhydrogen dimethyl-siloxane coolymers, alkyl methyl polysiloxanes, bis(dimethylsilyl)alkanes, bis(dimethylsilyl)benzene and a mixture thereof.

Examples of the preferred silicon hydride compounds are represented by the formula: 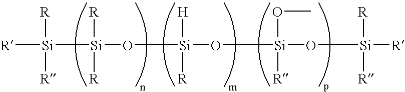
wherein each R is independently selected from the group consisting of alkyl groups having 1 to 20 carbon atoms and cycloalkyl and aryl groups having 4 to 12 carbon atoms, m is an integer of 1 to approximately 50, n is an integer of 1 to approximately 50, and p is an integer of 0 to approximately 6.

The amount of Compound (c) in the formulation is 2 to 25 parts by weight, preferably 5 to 25 parts by weight per 100 parts by weight of Compound (a). If it exceeds the upper limit, flowability of the thermoplastic elastomer composition will significantly decreases, which makes the production and molding difficult. If it is less than the lower limit, compression set and oil resistance of the thermoplastic elastomer composition will be worse.
Component (d):

Component (d) is at least one polymer selected from the group consisting of a copolymer of a vinyl aromatic compound with a conjugated diene compound (d-1), a hydrogenated copolymer obtained by hydrogenating a copolymer of a vinyl aromatic compound with a conjugated diene compound (d-2), and a hydrogenated polymer obtained by hydrogenating a polymer of a conjugated diene compound (d-3) Component (d) is used for the purpose of, particularly, improving compression set at high temperatures.
Component (d-1):

Component (d-1) includes a random copolymer of a vinyl aromatic compound with a conjugated diene compound (d-1-1), and a block copolymer of a vinyl aromatic compound with a conjugated diene compound (d-1-2).
Component (d-1-1):

omponent (d-1-1) is a random copolymer of a vinyl aromatic compound with a conjugated diene compound. The vinyl aromatic compound may be one or more selected from, for example, styrene, α-methylstyrene, vinyltoluene and p-tert.-butylstyrene. Styrene is especially preferred. The conjugated diene compound may be one or more selected from, for example, butadiene, isoprene, 1,3-pentadiene and 2,3-dimethyl-1,3-butadiene. Butadiene, isoprene and a combination thereof are especially preferred.

Component (d-1-1) is composed of3 to 60 parts byweight, preferably 5 to 50 parts by weight, of the vinyl aromatic compound.

The number average molecular weight of Component (d-1-1) is preferably in the range of 150,000 to 500,000, more preferably of 170,000 to 400,000, still more preferably 200,000 to 350,000, and its molecular weight distribution is 10 or less.

A specific example of Component (d-1-1) is, for example, a copolymer of styrene with butadiene (SBR).
Component (d-1-2):

Component (d-1-2) is a block copolymer of a vinyl aromatic compound with a conjugated diene, which copolymer is composed of at least two polymeric blocks (A) composedmainly of a vinyl aromatic compound, and at least one polymeric block (B) composed mainly of a conjugated diene compound. For example, a vinyl aromatic compound—conjugated diene compound block copolymer having a structure, A-B-A, B-A-B-A or A-B-A-B-A may be mentioned.

Component (d-1-2) comprises 5 to 60% by weight, preferably 20 to 50% by weight, of a vinyl aromatic compound.

Preferably, the polymeric block (A) composed mainly of a vinyl aromatic compound consists solely of a vinyl aromatic compound, or is a copolymeric block of at least 50% by weight, more preferably at least 70% by weight, of a vinyl aromatic compound and a conjugated diene compound.

Preferably, the polymericblock (B) composedmainlyofa conjugated diene compound consists solely of a conjugated diene compound or is a copolymeric block of at least 50% by weight, more preferably at least 70% by weight, of a conjugated diene compound and a vinyl aromatic compound.

A number average molecular weight of Component (d-1-2) is preferably in the range of 5,000 to 1,500,000, more preferably 10,000 to 550,000, still more preferably 100,000 to 400,000 and its molecular weight distribution is 10 or less. Molecular structure of the block copolymer may be linear, branched, radial or any combination thereof.

Further, in both the polymeric block (A) composed mainly of a vinyl aromatic compound and the polymeric block (B) composed mainly of a conjugated diene compound, a distribution of units derived from a conjugated diene compound or a vinyl aromatic compound in a molecular chain may be at random, tapered (i.e., a content of the monomeric component increases or decreases along a molecular chain.), in the form of partial block or any combination thereof. When two or more of the polymeric block (A) composed mainly of a vinyl aromatic compound or two or more of the polymeric block (B) composed mainly of a conjugated diene compound are present, they may be same with or different from each other in structure.

The vinyl aromatic compound to compose Component (d-1-2) may be one or more selected from, for example, styrene, α-methylstyrene, vinyltoluene and p-tert.-butylstyrene. Styrene is especially preferred. The conjugated diene compound may be one or more selected from, for example, butadiene, isoprene, 1,3-pentadiene and 2,3-dimethyl-1,3-butadiene. Butadiene, isoprene and a combination thereof are especially preferred.

Examples of Component (d-1-2) include styrene-butadiene-styrene copolymer (SBS) and styrene-isoprene-styrene copolymer (SIS).

A number of methods were proposed for the preparation of Component (d-1-2). In JP Publication 40-23798/1965 as a typical example, this may be obtained by carrying out block-polymerization with a lithium catalyst or a Ziegler catalyst in an inert medium.
Component (d-2):

Component (d-2) includes a hydrogenated copolymer of a random copolymer of a vinyl aromatic compound with a conjugated diene compound (d-2-1) and a hydrogenated copolymer of a block copolymer of a vinyl aromatic compound with a conjugated diene compound (d-2-2).
Component (d-2-1):

Component (d-2-1) is a hydrogenated copolymer obtained by hydrogenating a random copolymer of a vinyl aromatic compound with a conjugated diene compound. The vinyl aromatic compound may be one or more selected from, for example, styrene, t-butylstyrene, α-methylstyrene, p-methylstyrene, divinylbenzene, 1,1-diphenylstyrene, N,N-diethyl-p-aminoethylstyrene, vinyltoluene and p-tert.-butylstyrene. Styrene is especially preferred. The conjugated diene compound may be one or more selected from, for example, butadiene, isoprene, 1,3-pentadiene and 2,3-dimethyl-1,3-butadiene.

Component (d-2-1) preferably has amelt mass flow rate (as measured at 230° C. with a load of 21.18 N according to ASTM D 1238) of 12 g/10 minute or less, more preferably 6 g/10 minute or less in view of a tensile property and heat distortion resistance.

A content of a vinyl aromatic compound is preferably 50% by weight or less. It is more preferably 25% by weight or less, still more preferably 20% by weight or less, for the purpose of obtaining a flexible resin composition. Also for the same purpose, it is important to hydrogenate carbon-carbon double bonds in the conjugated diene compound.

In a random copolymer of a vinyl aromatic compound and a conjugated diene compound, the vinyl aromatic compound distributes at random. Preferably, at least 90% of carbon-carbon double bonds in the conjugated diene compound are hydrogenated.

A number average molecular weight of Component (d-2-1) is preferably in the range of 5,000 to 1,000,000, more preferably 10,000 to 350,000 and its molecular weight distribution is 10 or less.

Examples of Component (d-2-1) include, for example, a hydrogenated copolymer obtained by hydrogenating styrene-butadiene random copolymer (hydrogenated SBR or H-SBR). As a commercial available one, Dynalon 1320P (ex JSR Co.) is mentioned.
Component (d-2-2):

Component (d-2-2) is a hydrogenated copolymer of ablock copolymer of a vinyl aromatic compound with a conjugated diene compound, and is obtained by hydrogenating a block copolymer which is composed of at least one polymeric block (A) composed mainly of a vinyl aromatic compound and at least one polymeric block (B) composed mainly of a conjugated diene compound. For example, it may be obtained by hydrogenating a vinyl aromatic compound—conjugated diene compound block copolymer having a structure, A-B, A-B-A, B-A-B-A or A-B-A-B-A may be mentioned.

The polymeric block (A) composed mainly of a vinyl aromatic compound may consist solely of a vinyl aromatic compound, or be a copolymeric block of a vinyl aromatic compound and less than 50% by weight of a conjugated diene compound. The polymeric block (B) composed mainly of a conjugated diene compound may consist solely of a conjugated diene compound or be a copolymeric block of a conjugated diene compound and less than 50% by weight of a vinyl aromatic compound.

The vinyl aromatic compound to compose Component (d-2-2) may be one or more selected from, for example, styrene, α-methylstyrene, vinyltoluene and p-tert.-butylstyrene. Styrene is especially preferred. The conjugated diene compound may be one or more selected from, for example, butadiene, isoprene, 1,3-pentadiene and 2,3-dimethyl-1,3-butadiene. Butadiene, isoprene and a combination thereof are especially preferred.

A hydrogenation ratio in Component (d-2-2) may be optional, but is preferably 50% or more, more preferably 55% or more, still more preferably 60% or more, in the polymeric block (B) composed mainly of a conjugated diene compound. The microstructure of the polymeric block (B) may be optional. For example, where the block (B) is composed solely of butadiene, 1,2-micro structure accounts preferably for 20 to 50% by weight, particularly preferably 25 to 45% by weight, of the polybutadiene block. The 1,2-bonds may selectively be hydrogenated. In a case where the block (B) is composed of a mixture of isoprene and butadiene, the 1,2-micro structure accounts preferably for less than 50% by weight, more preferably less than 25% by weight, and still more preferably less than 15% by weight.

Where the block (B) is composed solely of isoprene, it is preferred that 70 to 100% by weight of isoprene in the polyisoprene block has 1,4-micro structure and at least 90% of the aliphatic double bonds derived from isoprene is hydrogenated.

It is preferred that the polymeric block (A) constitutes 5 to 70% by weight of the component. The weight average molecular weight of the component is preferably 150,000 to 500,000, more preferably 200,000 to 400,000. If the weight average molecular weight is less than 200,000, compression set of the composition obtained will be worse. Within the aforesaid range, higher the molecular weight, better the compression set of the composition obtained.

Examples of Component (d-2-2) include styrene-ethylene-butene copolymer (SEB), styrene-ethylene-propylene copolymer (SEP), styrene-ethylene-butene-styrene copolymer (SEBS), styrene-ethylene-propylene-styrene copolymer (SEPS), styrene-ethylene-ethylene-propylene-styrene copolymer (SEEPS) and styrene-butadiene-butylene-styrene copolymer (partially hydrogenated styrene-butadiene-styrene copolymer, SBBS). They may be used appropriately according to applications.

A number of methods were proposed for the preparation of Component (d-2-2). In JP Publication 40-23798/1965 as a typical example, a block copolymer of a vinyl aromatic compound with a conjugated diene compound may be obtained by carrying out block-polymerization with a lithium catalyst or a Ziegler catalyst in an inert medium. This block copolymer is then subjected to hydrogenation. The hydrogenation may be carried out in any known method, for example, in an inert solvent in the presence of a hydrogenation catalyst.
Component (d-3):

Component (d-3) is a hydrogenated polymer obtained by hydrogenating a polymer of a conjugated diene compound and may be, for example, a block copolymer (CEBC) having a crystalline ethylene block and an amorphous ethylene-butene block, as obtained by hydrogenating a polymer of butadiene. Component (d-3) may be used alone or as a mixture of two or more of such.

A weight average molecular weight of Component (d-3) is 500,000 or less, preferably 200,000 to 450,000. If the weight average molecular weight exceeds 500,000, extrusion or injection molding processability will be worse. If the weight average molecular weight is less than 200,000, the effect of improving compression set will be decreased.

Among the aforesaid component (d), Component (d-2-2) is preferred, because it is excellent in giving flexibility and improving compression set. Especially, styrene-ethylene-ethylene-propylene-styrene copolymer (SEEPS) and styrene-ethylene-butene-styrene copolymer (SEBS) are more preferred. Particularly, SEPTON 4077 (ex Kuraray Co.) and KRATON MD6933ES (ex Kraton Polymers Japan) are most preferred because of their excellence in improving compression set.

The amount of Component (d) in the formulation is 5 to 120 parts by weight, preferably 10 to 100 parts by weight, per 100 parts by weight of Component (a). If it is less than 5 parts by weight, compression set of the composition obtained will be worse. If it exceeds 120 parts by weight, oil resistance and compression set of the composition obtained will be worse.
Component (e): cross-linking promoter (optional component):

Component (e) is an optional component and may be used to more effectively improve the function of Component (c), cross-linking agent. When a phenolic resin is used as Component (c), zinc oxide, magnesium oxide or tin dichloride may be used as Component (e). Where zinc oxide is used as a cross-linking catalyst, a metal salt of stearic acid may be used together as a dispersant. Among the aforesaid cross-linking promoters, zinc oxide is particularly preferred.

Component (e) may be blended in an amount of 20 parts by weight or less per 100 parts by weight of Component (a). Particularly, when Component (e) is zinc oxide, its amount is preferably 0.05 to 20 parts by weight per 100 parts by weight of Component (a). When Component (e) is tin dichloride, its amount is preferably 0.1 to 10 parts by weight per 100 parts by weight of Component (a). If the amount of Component (e) exceeds the aforesaid upper limit, no homogeneous cross-linking is yielded. In addition, flowability of the thermoplastic elastomer composition obtained decreases, which makes the production and molding difficult, and whitening on bending, fatigue on bending and bleeding-out of oil and compression set will be worse.

In the present invention, the combination of a phenolic resin asComponent (c) withtindichlorideasComponent (e) isparticularly preferred because good compression set at high temperatures can be achieved.
Component (f): non-aromatic softening agent for rubber (optional component):

Component (f) is an optional component and may be used for the purpose of providing the thermoplastic elastomer composition with flexibility and improved moldability.

Examples of the non-aromatic softening agent for rubber include, for example, paraffinic compounds having 4 to 155 carbon atoms, preferably 4 to 50 carbon atoms. Specifically mentioned are n-paraffins (saturated linear hydrocarbons) such as butane, pentane, hexane, heptane, octane, nonane, decane, undecane, dodecane, tetradecane, pentadecane, hexadecane, heptadecane, octadecane, nonadecane, eicosane, heneicosane, docosane, tricosane, tetracosane, pentacosane, hexacosane, heptacosane, octacosane, nonacosane, triacontane, hentriacontane, dotriacontane, pentatriacontane, hexacontane and heptacontane; isoparaffins (saturated branched hydrocarbons) such as isobutane, isopentane, neopentane, isohexane, isopentane, neohexane, 2,3-dimethylbutane, 2-methylhexane, 3-methylhexane, 3-ethylpentane, 2,2-dimethylpentane, 2,3-dimethylpentane, 2,4-dimethylpentane, 3,3-dimethylpentane, 2,2,3-trimethylbutane, 3-methylheptane, 2,2-dimethylhexane, 2,3-dimethylhexane, 2,4-dimethylhexane, 2,5-dimethylhexane, 3,4-dimethylhexane, 2,2,3-trimethylpentane, isooctane, 2,3,4-trimethylpentane, 2,3,3-trimethylpentane, 2,3,4-trimethylpentane, isononane, 2-methylnonane, isodecane, iso-undecane, isododecane, isotridecane, isotetradecane, isopentadecane, iso-octadecane, isonanodecane, iso-eicosane and 4-ethyl-5-methyloctane; and derivatives of these saturated hydrocarbons. These non-aromatic softening agents for rubber may be used in a mixture of two or more of them. Of these agents, ones which are liquid at room temperature are preferred.

Commercially available non-aromatic softening agents for rubber which are liquid at room temperature include NA Solvent (isoparaffinic hydrocarbon oil) ex Nippon Fats & Oils Co., PW-90 (n-paraffinic process oil) ex Idemitsu Kosan Co., IP-Solvent 2835 (synthetic isoparaffinic hydrocarbon composed with 99.8% by weight or more of isoparaffins) ex Idemitsu Petrochemical Co., and Neothiozol (n-paraffinic process oil) ex Sanko Chemical Co.

A small amount of unsaturated hydrocarbons or derivatives therefrom may be present in the non-aromatic softening agent for rubber. As the unsaturated hydrocarbons, there may be mentioned ethylene type of hydrocarbons such as ethylene, propylene, 1-butene, 2-butene, isobutylene, 1-pentene, 2-pentene, 3-methyl-1-butene, 3-methyl-1-butene, 2-methyl-2-butene, 1-hexene, 2,3-dimethyl-2-butene, 1-heptene, 1-octene, 1-nonene and 1-decene; and acetylene type of hydrocarbons such as acetylene, methylacetylene, 1-butyne, 2-butyne, 1-pentyne, 1-hexyne, 1-octyne, 1-nonyne and 1-decyne.

The amount of Component (f) in the formulation is 480 parts by weight or less, preferably 260 parts by weight or less based on 100 parts by weight of Component (a). The amount is preferably at least 10 parts by weight based on 100 parts by weight of Component (a). If it exceeds the upper limit, breeding-out tends to occur on the surface of a shaped article, and mechanical properties and compression set will be worse.
Component (g): organic peroxide (optional component):

Component (g) is an optional component and may be used for the purpose of further improving compression set of the thermoplastic elastomer composition.

Examples of Component (g) include, for example, 1,1-bis(t-hexylperoxy)-3,3,5-trimethylcyclohexane, 1,1-bis(t-butylperoxy)-3,3,5-trimethylcyclohexane, benzoylperoxide, m-methylbenzoylperoxide, m-toluoylperoxide, t-hexylperoxybenzoate, 1,1-bis(t-butylperoxy)2-methylcyclohexane, 1,1-bis(t-hexylperoxy)cyclohexane, 1,1-bis(t-butylperoxy)cyclohexane, 2,2-bis(4,4-dibutylperoxycyclohexyl)propane, 1,1-bis(t-butylperoxy)cyclododecane, t-hexylperoxyisopropylmonocarbonate, succinic acid peroxide, 1-cyclohexyl-1-methyethylperoxy-2-ethylhexanoate, t-hexylperoxy-2-ethylhexanoate, t-butylperoxy-2-ethylhexanoate, m-toluoyl- and benzoyl-peroxide, t-butylperoxyisobutyrate, t-butylperoxylaurate, 2,5-dimethyl-2,5-di(m-toluoylperoxy)hexane, t-butylperoxyisopropylmonocarbonate, t-butylperoxy-2-ethylhexylmonocarbonate, 2,5-dimethyl-2,5-di(benzoylperoxy)hexane, t-butylperoxyacetate, 2,2-bis(t-butylperoxy)butane, dicumylperoxide, di-tert-butylperoxide, 2,5-dimethyl-2,5-di(tert-butylperoxy)hexane, 2,5-dimethyl-2,5-di(tert-butylperoxy)hexyne-3,1,3-bis(tert-butylperoxyisopropyl)benzene, 1,1-bis(tert-butylperoxy)-3,3,5-trimethylcyclohexane, n-butyl-4,4-bis(tert-butylperoxy)valerate, benzoylperoxide, p-chlorobenzoylperoxide, 2,4-dichlorobenzoylperoxide, tert-butylpeoxybenzoate, tert-butylperoxyisopropylcarbonate, diacetylperoxide, lauroylperoxide and tert-butylcumylperoxide.

Among them, preferred are 1,1-bis(t-hexylperoxy)-3,3,5-trimethylcyclohexane (with one-minute half life temperature of 147° C.), 2,5-dimethyl-2,5-di(tert-butylperoxy)hexane (with one-minute half life temperature of 179° C.) and 2, 5-dimethyl-2,5-di(tert-butylperoxy)hexyne-3 (with one-minute half life temperature of 194° C.) in terms of odor, discoloration and scorch resistance. In the present composition, low temperature-decomposing organic peroxides may be used which have one-minute half life temperature of 165° C. or lower.

Where Component (g) is blended, the amount is 0.01 to 0.5 part by weight, preferably 0.01 to 0.3 part by weight, per 100 parts by weight of Component (a). If the amount exceeds 0.5 part by weight, decomposition reaction caused by the organic peroxide will be overwhelming to deteriorate compression set of the composition obtained.
Other components:

The thermoplastic elastomer composition according to the present invention may further contain a heat stabilizer, an antioxidant, a light stabilizer, a UV stabilizer, a crystallization nucleating agent, an anti-blocking agent, a sealing aid, a release agent such as stearic acid and silicone oil, a slipping agent such as polyethylene wax, colorant, pigment, an inorganic filler (alumina, talc, calcium carbonate, mica, wollastonite, clay and carbon), a foaming agent (organic and inorganic), and a flame retardant (a metal hydrate, red phosphorus, ammonium polyphosphate, antimony and silicone) as long as the purpose of the invention is not impeded.

The antioxidant includes phenolic antioxidants such as 2,6-di-tert-p-butyl-p-cresol, 2,6-di-tert-butylphenol,2,4-dimethyl-6-tert-butylphenol, 4,4-dihydroxydiphenyl and tris(2-methyl-4-hydroxy-5-tert-butylphenyl)butane; phosphite-type antioxidants; and thioether-type antioxidants. Among them, the phenolic antioxidants and the phosphite-type antioxidants are particularly preferred.

2. Production of the Thermoplastic Elastomer Composition

The thermoplastic elastomer composition according to the present invention may be produced by adding and melt kneading, simultaneously orinany order, the aforesaid Components (a) to (d) and, optionally, the other components. Preferably, the composition may be produced by simultaneously adding and melt kneading the Components (a) to (d) and, optionally, the other components.

A method for the melt kneading is not particularly limited, but may be any one of publicly known methods, such as, for example, single-screw extruders, twin-screw extruders, rolls, Bunbary mixers and various kneaders. The above said operations may be carried out successively using, for example, a twin-screw extruder, Bunbary mixer or pressure kneader with appropriate L/D. Here, a temperature in the melt kneading is preferably 160 to 240° C. The kneading time is preferably 5 to 20 minutes, more preferably 5 to 10 minutes, to develop the cross-linking well.

3. Applications

Since the thermoplastic elastomer composition according to the present invention is superior in compression set and oil resistance at high temperatures and in moldability, it can be used in articles, as mentioned in the next paragraph, which are molded by blow molding, extrusion molding, injection molding, thermo-forming, elasto-welding, compression molding or the like.

Specifically mentioned are automobile parts including, for example, lighting gaskets, 3D-exchange-blow molded clean air ducts, hood seal hinge covers, belly pans (robot-technology extrusion molded gaskets), cup holders, side brake grips, shift knob covers, seat adjusting knobs, IP skins, flapper door seals, wire harness grommets, rack and pinion boots, suspension cover boots (strutcover boots), glass guides, inner belt line seals, roof guides, trunk lid seals, molded quarter window gaskets, corner moldings, glass encapsulations (robot-technology extrusion molded), hood seals, glass encapsulations (injection molded), glass run channels and secondary seals. As industrial parts, there are specifically mentioned curtainwall gaskets for high-rise buildings, window frame seals, adhesion to metals/fiber reinforcement, parking deck seals, expansion joints, anti-earthquake expansion joints, house window and door seals (for example, co-extrusion molded), house door seals, handrail skins, walking mats (sheets), foot rubbers, washing machine drain hoses (double molded with PP), washing machine lid seals, air conditioner motor mounts, drainpipe seals (double molded with PP), riser tubes, pipe (made of PVC) joint packings, caster wheels, printer rolls, duct hoses, wires and cables, and syringe gaskets. Further, as commodity goods or parts, mentioned are speaker surrounds, hair brush grips, razor grips, cosmetic container grips and feet, toothbrush grips, commodity brush grips, broom bristles, kitchen ware grips, measuring spoon grips, pruning shears grips, heat resistant glass ware lids, gardening ware grips, scissors grips, stapler grips, computer mice, golf bag parts, trowel grips, chain saw grips, screw driver drips, hammer grips, power drill grips, grinder grips and alarm clocks.

As other specific applications, there are mentioned vehicle parts such as weather seals, brake parts such as cups, coupling disks and diaphragm cups, boots such as constant velocity joints and rack transmission joints, tubing, sealing gaskets, parts of hydraulically or pneumatically operated apparatus, O-rings, pistons, valves, valve seats, valve guides, and other elastomeric polymer based-parts or elastomeric polymers combined with other materials such as combined metal/plastic materials, V-belts, toothed belts with truncated ribs containing fabric faced V's and transmission belts comprising molded rubber with ground short fiber reinforced V's or short fiber flocked V's.

The present invention will now be elucidated by referring to the Examples and Comparative Examples without being limited thereto. Test methods and materials used in the Examples and Comparative Examples are as follows.

1. Test Methods

(1) Specific gravity: determined in accordance with JIS (Japanese Industrial Standards) K 7112 on a specimen of a pressed sheet having a thickness of 1 mm.

(2) Hardness: determined in accordance with JIS K7215ona specimen of a pressed sheet having a thickness of 6.3 mm with a Durometer, hardness: type A.

(3) Tensile Strength, 100% Modulus and Elongation: determined in accordance with JIS K 6301 on a specimen which was obtained by punching out a pressed sheet having a thickness of 1 mm by a No. 3 dumbbell die. The tensile speed was 500 mm/min.

(4) Compression set: determined in accordance with JIS K 6262 under the condition of 25% deformation at 120° C. for 22 hours. A pressed sheet having a thickness of 6.3 mm was used as a specimen.

(5) Coefficient of volume expansion (%) (evaluation of oil resistance): determined in accordance with JIS K 6258 on a specimen of a pressed sheet having a thickness of 2 mm. A coefficient of volume expansion after immersion in IRM #902 at 120° C. for 72 hours was determined.

(6) Productivity: determined by carrying out melt kneading with a 3L-volume pressure kneader type mixer at 180° C. for 10 to 30 minutes to produce a composition. The composition was rated on the following criteria.

∘: The composition produced was thermoplastic.

X: The composition produced was not thermoplastic.

(7) Extrusion moldability: determined by extrusion molding a composition into a plate of 50 mm in width ×0.5 mm in thickness at 200 to 220° C. using a 40 mm extruder. The surface appearance and the shape of the plate were observed to rate on the following criteria.

∘: The plate had a good specular surface and the intended shape with no hard spot on its surface.

X: The plate had worse specular surface or had patterns, round edge or hard spots on its surface, or the generation of die build-up was observed.

(8) Injection moldability: determined by injection molding a composition into a sheet of 130 mm×130 mm×2 mm at 200 to 220° C. using a 120 tons injection molding machine. The sheet was visually observed whether flow marks, sink marks or hard spots were present on its surface to rate on the following criteria.

∘: The sheet had a good specular surface with no hard spot.

X: The sheet had patterns which were caused by delamination, or had flow marks or hard spots on its surface.

2. Materials

Component (a):

Nordel IP 4760P (ex DuPont Dow Elastomers Japan Co.), ethylene-propylene-ethyliden norbornene copolymer rubber (EPDM) synthesized with a metallocene catalyst; specific gravity, 0.86; Mooney viscosity ML₁₊₄ (125° C.), 70 (ASTM D-1646); weight average molecular weight, 210,000; ethylene content, 67%; ENB content, 4.9%; melting point, 5° C.
Comparative component (a):

EP57P (ex JSR), ethylene-propylene-ethyliden norbornene copolymer rubber (EPDM) synthesized with a non-metallocene catalyst (Ziegler catalyst); specific gravity, 0.86; Mooney viscosity ML₁₊₄ (100° C.), 88 (ASTM D-1646); iodine number, 15; MFR, 0.4 g/10 min. (230° C., a load of 2.16 kg); hardness, 55 (JIS A); ethylene content, 66% by weight; ENB content, 4.5% by weight
Component (b):

Novatec BC08AHA (ex Nippon Polychem Co.), polypropylene; density, 0.902 g/cm³; hardness, 94 (Shore A); MFR (230° C., load of 21.18 N), 80 dg/min.; weight average molecular weight, 100,000; melting point, 160° C.
Component (c):

Tackrol 201 (ex Taoka Chemical Co.), alkylphenol-formaldehyde resin
Component (d-1-1):

SL552 (ex JSR), SBR (styrene-butadiene copolymer); styrene, 24%; Mooney viscosity ML₁₊₄ (100° C.), 55; amount of vinyl bonds, 39%; specific gravity, 0.94
Component (d-1-2):

VECTOR 2518 (ex DEXCO POLYERS), SBS (styrene-butadiene-styrene copolymer)
Component (d-2-2)

SEPTON 4077 (ex Kuraray Co.), SEEPS (styrene-ethylene-ethylene-propylene-styrene copolymer); styrene content, 30% by weight; number average molecular weight, 260,000; weight average molecular weight, 320,000; molecular weight distribution, 1.23; ratio of hydrogenation, 90% or more
Component (d-3):

DYNARON HSB1729 (ex JSR), CEBC; specific gravity, 0.88; hardness, 73A; glass transition point, −50° C. (ASTM D3418); MFR, 0.5g/10 min. (230° C., 98N, ASTM D1238)
Component (e)

Zinc oxide, two types of zinc oxide (ex Sakai Chemical Co.)
Component (e)

Tin dichloride, anhydrous tin dichloride (ex Showa Kako Corp.)
Component (f)

PW-90 (ex Idemitsu Kosan Co.), paraffin oil
Component (g)

Organic peroxide: Perhexa 25B (ex Nippon Fats & Oils Co.), 2,5-dimethyl-2,5-di(t-butylperoxy)-hexane

### EXAMPLES 1 TO 9 AND COMPARATIVE EXAMPLES 1 TO 7

The components in the amounts (parts by weight) as shown in Tables 1 and 2 were charged into a 3L-volume pressure kneader type mixer and melt kneaded at 180 for 10 to 30 minutes, followed by pelletization.

TABLE 1

| | | Example 1 | Example 2 | Example 3 | Example 4 | Example 5 |
|---|---|---|---|---|---|---|
| Component | Component (a) Nordel IP 4760P | 100 | 100 | 100 | 100 | 100 |
| | Component (b) BC08AHA | 65 | 65 | 65 | 65 | 65 |
| | Component (c) Tackrol 201 | 10 | 10 | 10 | 10 | 10 |
| | Component (d-2-2) SEEPS | 35 | | | | |
| | Component (d-2-2) SBBS | | 35 | | | |
| | Component (d-3) CEBC | | | 35 | | |
| | Component (d-1-2) SBS | | | | 35 | |
| | Component (d-1-1) SBR | | | | | 35 |
| | Component (e) Zinc oxide | | | | | |
| | Component (e) Tin dichloride | | | | | |
| | Component (f) PW-90 | | | | | |
| | Component (g) Organic peroxide | | | | | |
| Results of | Specific gravity | 0.91 | 0.91 | 0.91 | 0.91 | 0.91 |
| rating | Hardness (Shore A) | 86 | 85 | 85 | 86 | 85 |
| | Tensile strength (MPa) | 16.7 | 16 | 17.1 | 16.2 | 13.4 |
| | 100% Modulus (MPa) | 6.1 | 6 | 6.1 | 5.8 | 5.7 |
| | Elongation (%) | 570 | 550 | 560 | 600 | 530 |
| | Compression set | 42 | 44 | 45 | 41 | 45 |
| | (120° C. × 22 h) (%) | | | | | |
| | Coefficient of | 48 | 52 | 50 | 44 | 50 |
| | volume expansion | | | | | |
| | (120° C. × 72 h) (%) | | | | | |
| | Productivity | ◯ | ◯ | ◯ | ◯ | ◯ |
| | Extension moldability | ◯ | ◯ | ◯ | ◯ | ◯ |
| | Injection moldability | ◯ | ◯ | ◯ | ◯ | ◯ |

| | | Example 6 | Example 7 | Example 8 | Example 9 |
|---|---|---|---|---|---|
| Component | Component (a) Nordel IP 4760P | 100 | 100 | 100 | 100 |
| | Component (b) BC08AHA | 65 | 65 | 65 | 65 |
| | Component (c) Tackrol 201 | 10 | 10 | 10 | 10 |
| | Component (d-2-2) SEEPS | 35 | 35 | 35 | 35 |
| | Component (d-2-2) SBBS | | | | |
| | Component (d-3) CEBC | | | | |
| | Component (d-1-2) SBS | | | | |
| | Component (d-1-1) SBR | | | | |
| | Component (e) Zinc oxide | 3 | | | |
| | Component (e) Tin dichloride | | 2 | | |
| | Component (f) PW-90 | | | 100 | |
| | Component (g) Organic peroxide | | | | 0.1 |
| Results of | Specific gravity | 0.91 | 0.91 | 0.91 | 0.91 |
| rating | Hardness (Shore A) | 87 | 86 | 68 | 88 |
| | Tensile strength (MPa) | 16.8 | 16.2 | 11.2 | 14.5 |
| | 100% Modulus (MPa) | 6.3 | 6.5 | 2.9 | 5.9 |
| | Elongation (%) | 510 | 500 | 730 | 480 |
| | Compression set | 40 | 39 | 40 | 38 |
| | (120° C. × 22 h) (%) | | | | |
| | Coefficient of | 44 | 43 | 88 | 42 |
| | volume expansion | | | | |
| | (120° C. × 72 h) (%) | | | | |
| | Productivity | ◯ | ◯ | ◯ | ◯ |
| | Extension moldability | ◯ | ◯ | ◯ | ◯ |
| | Injection moldability | ◯ | ◯ | ◯ | ◯ |

TABLE 2

| | | Comp. Ex. 1 | Comp. Ex. 2 | Comp. Ex. 3 | Comp. Ex. 4 |
|---|---|---|---|---|---|
| Component | Component (a) Nordel IP 4760P | 100 | 100 | 100 | 100 |
| | Comparative component (a) EP57P | | | | |
| | Component (b) BC08AHA | 10 | 360 | 65 | 65 |
| | Component (c) Tackrol 201 | 10 | 10 | 1 | 30 |
| | Component (d-2-2) SEEPS | 35 | 35 | 35 | 35 |
| Results of | Specific gravity | 0.91 | 0.91 | 0.91 | 0.91 |
| rating | Hardness (Shore A) | 62 | 95 | 67 | 86 |
| | Tensile strength (MPa) | 6.5 | 29.3 | 7.6 | 10.2 |
| | 100% Modulus (MPa) | 1.8 | 11.5 | 3.1 | 6.4 |
| | Elongation (%) | 760 | 390 | 820 | 240 |
| | Compression set (120° C. × 22 h) (%) | 42 | 83 | 80 | 39 |
| | Coefficient of volume expansion (120° C. × 72 h) (%) | 84 | 29 | 160 | 49 |
| | Productivity | X | ◯ | ◯ | X |
| | Extension moldability | X | ◯ | ◯ | X |
| | Injection moldability | X | ◯ | ◯ | X |

| | | Comp. Ex. 5 | Comp. Ex. 6 | Comp. Ex. 7 |
|---|---|---|---|---|
| Component | Component (a) Nordel IP 4760P | 100 | 100 | |
| | Comparative component (a) EP57P | | | 100 |
| | Component (b) BC08AHA | 65 | 65 | 65 |
| | Component (c) Tackrol 201 | 10 | 10 | 10 |
| | Component (d-2-2) SEEPS | 3 | 130 | 35 |
| Results of | Specific gravity | 0.91 | 0.91 | 0.91 |
| rating | Hardness (Shore A) | 88 | 82 | 85 |
| | Tensile strength (MPa) | 17.5 | 13.1 | 14.5 |
| | 100% Modulus (MPa) | 7.1 | 5.6 | 5.8 |
| | Elongation (%) | 480 | 550 | 510 |
| | Compression set (120° C. × 22 h) (%) | 61 | 65 | 45 |
| | Coefficient of volume expansion (120° C. × 72 h) (%) | 40 | 170 | 50 |
| | Productivity | ◯ | ◯ | ◯ |
| | Extension moldability | ◯ | ◯ | X |
| | Injection moldability | ◯ | ◯ | X |

As seen from Table 1, the thermoplastic elastomer compositions according to the present invention had good properties (Examples 1 to 9).

On the other hand, as seen in Table 2, the composition of Comparative Example 1, where the amount of Component (b) is below the lower limit of thepresent invention, was inferior inoil resistance, productivity and moldability, and the composition of Comparative Example 2, where the amount of Component (b) exceeds the upper limit of the present invention, was inferior in compression set. The composition of Comparative Example 3, where the amount of Component (c) is below the lower limit of the present invention, was inferior in compression set and oil resistance, and the composition of Comparative Example 4, where the amount of Component (c) exceeds the upper limit of the present invention, was inferior in productivity and moldability. The composition of Comparative Example 5, where the amount of Component (d) is below the lower limit of the present invention, was inferior in compression set, and the composition of Comparative Example 6, where the amount of Component (d) exceeds the upper limit of the present invention, was inferior in compression set and oil resistance. In the composition of Comparative Example 7, EPDM synthesized with a Ziegler catalyst was used instead of Component (a). This composition was inferior inmoldability and, particularly, significantly generated die build-up in extrusion molding.

1. A thermoplastic elastomer composition, characterized in that it comprises
(a) 100 parts by weight of an ethylene-α-olefin-unconjugated polyene copolymer rubber synthesized with a metallocene catalyst,
(b) 20 to 350 parts by weight of a crystalline olefin resin,
(c) 2 to 25 parts by weight of a cross-linking agent, and
(d) 5 to 120 parts by weight of at least one polymer selected from the group consisting of a copolymer of a vinyl aromatic compound with a conjugated diene compound, a hydrogenated copolymer obtained by hydrogenating a copolymer of a vinyl aromatic compound with a conjugated diene compound, and a hydrogenated polymer obtained by hydrogenating a polymer of a conjugated diene compound.

2. A thermoplastic elastomer composition according to claim 1, wherein it further comprises (e) a cross-linking promoter in an amount of 20 parts by weight or less.

3. A thermoplastic elastomer composition according to claim 2, wherein the component (e) is at least one selected from the group consisting of zinc oxide, magnesium oxide and tin dichloride.

4. A thermoplastic elastomer composition according to claim 2, wherein the component (e) is zinc oxide in the amount of 0.05 to 20 parts by weight.

5. A thermoplastic elastomer composition according to claim 2, wherein the component (e) is tin dichloride in the amount of 0.1 to 10 parts by weight.

6. A thermoplastic elastomer composition according to claim 1, wherein it further comprises (f) a non-aromatic softening agent for rubber in an amount of 480 parts by weight or less.

7. A thermoplastic elastomer composition according to claim 1, wherein the component (c) is at least one selected from the group consisting of phenolic resins and brominated phenolic resins.

8. A thermoplastic elastomer composition according to claim 1, wherein the component (c) is an alkylphenol-formaldehyde resin.

9. A thermoplastic elastomer composition according to claim 1, wherein it comprises (g) an organic peroxide in an amount of 0.01 to 0.5 part by weight.

10. A shaped article obtained from a thermoplastic elastomer composition according to claim 1.
